(19) United States
(12) Patent Application Publication
(10) Pub. No.: US 2020/0153615 A1
(43) Pub. Date: May 14, 2020

(54) METHOD FOR INFORMATION VERIFICATION IN DISTRIBUTED SYSTEMS

(71) Applicant: COBINHOOD LTD., Taipei City (TW)

(72) Inventors: Tai-Yuan CHEN, Taipei City (TW); Wei-Ning HUANG, Taipei City (TW); Po-Chun KUO, Taipei City (TW); Hao CHUNG, Taipei City (TW); Tzu-Wei CHAO, Taipei City (TW)

(21) Appl. No.: 16/678,645

(22) Filed: Nov. 8, 2019

Related U.S. Application Data
(60) Provisional application No. 62/757,423, filed on Nov. 8, 2018.

(51) Int. Cl. H04L 9/08; G06Q 40/00; G06Q 20/38

(52) U.S. Cl. CPC H04L 9/088; G06Q 2220/00; G06Q 20/3829; G06Q 40/12

(57) ABSTRACT

A method for a node to issue a new block is used for a distributed system in which transactions and records are organized in block. The method comprises the steps of: determining a value R from a common reference string; computing a value s associated to a value of a status with a private key at a node, wherein the private key is a private signing key corresponding to the node, and the value s can only be computed by the node with the private key; computing a value r by taking the value s into a function H at the node, wherein the value r is unpredictable and unique to other nodes; and determining whether the node obtains a right to issue a new block by taking the values R and r into a function V.

### CROSS-REFERENCE TO RELATED APPLICATION

This patent application claims the benefit of U.S. Provisional Application No. 62/757,423 filed Nov. 8, 2018 and the disclosure is incorporated herein by reference in its entirety.

### BACKGROUND OF THE INVENTION

### 1. Field of the Invention

The invention relates to a method for a node being allowed to issue a new block in a distributed system in which transactions and records are organized in blocks, and particularly, to a new block committed to a blockchain in a blockchain network by using a common reference string and a verifiable random function.

### 2. Description of Related Art

Blockchains or blockchain is a distributed database that keeps a continuously growing list of data records. Each data record is protected against tampering and revisions. Blockchains are used with public ledgers of transactions, where the record is enforced cryptographically. Such a blockchain system is a replicated state machine that must be fault tolerant. When designing a blockchain system, there is usually a trade-off between decentralization, scalability and security, which is called the trilemma problem in blockchains. The blockchain trilemma is one of the biggest challenges for cryptocurrencies.

Blockchain systems are being challenged to demonstrate rigorous robustness and high performance in real-world situations. Many applications demand low transaction confirmation latency and high transaction throughput. However, most blockchain systems do not satisfy these criteria. For example, the confirmation latency of Ethereum (with traditional minute-level latency) is about 5 to 10 minutes and the throughput is limited to about 30 transactions per second. By contrast, some blockchain systems achieve high performance but sacrifice the robustness of the systems. For example, EOS achieves high performance, but it is operated with only 21 supernodes, and is vulnerable to DDoS attacks. PCT International Publication No. 2017/192837 discloses Algorand's techniques that are decentralized and have robust safety, which is incorporated herein by this reference, but Algorand's throughput is limited.

Thus, there is a need for a novel blockchain system which achieves high scalability while remaining decentralized and robust in the real-world environment. The application provides a method for a node allowed to issue a new block in a distributed system in which transactions and records are organized in blocks so as to achieve high decentralization and low latency.

### SUMMARY OF THE INVENTION

The present application provides a method for a node being allowed to issue a new block is described herein. The method is executed in a distributed system including a plurality of blocks, comprises: determining a value R from a common reference string; computing a value s associated to a value of a status with a private key at a node; computing a value r by taking the value s into a function H at the node; and determining whether the node obtains a right to issue a new block by taking the values R and r into a function V. The private key may be a private signing key corresponding to the node. The value s may only be computed by the node with the private key. The value r may be unpredictable and unique to other nodes.

In another embodiment, the value r can be verified with a public key and the value s. The status may be defined to be a shard ID, a chain ID or a height of the block.

In another embodiment, the common reference string may be a public randomness generated by a deterministic algorithm for each epoch. The epoch may consist of a specific number of blocks.

In another embodiment, the common reference string is defined as: Rᵢ=Hash(TSig(Rᵢ₋₁)), where Rᵢ is generated for the new block, and TSig(⋅) is a threshold signature function whose input is some set of share-signatures produced during previous blocks.

In another embodiment, the common reference string is defined as: Rᵢ=(Sig_{authority}(Rᵢ₋₁)), where Rᵢ is generated for the new block.

In another embodiment, the function H may be a hash function. The function V is defined as: |R−Hash(Sigₛₖ (status))|, where R is the value R and Hash(Sigₛₖ(status) can be verified by a public key.

In another embodiment, the node obtains the right to issue the new block when a calculated value for the function V is the minimum at the node by comparing with other calculated values for the function at other nodes. The blocks may pertain to a single blockchain.

The present application further provides a method for a node being allowed to issue a new block. The method is executed in a distributed system including a plurality of blocks, comprises: determining a value R from a common reference string; computing a value s associated to a value of a status at a node; computing a value r by taking the value s into a function H at the node; and determining whether the node obtains a right to issue a new block by taking the values R and r into a function V. The value s can be verified by other nodes.

In another embodiment, the value r may be unpredictable and unique to other nodes. The value r can be verified with a public key and the value s.

In another embodiment, the status can be defined to be a shard ID, a chain ID or a height of the block.

In another embodiment, the common reference string may be a public randomness generated by a deterministic algorithm for each epoch. The epoch consists of a specific number of blocks.

In another embodiment, the common reference string is defined as: Rᵢ=Hash(TSig(Rᵢ₋₁)), where Rᵢ is generated for the new block, and TSig(⋅) is a threshold signature function whose input is some set of share-signatures produced during previous blocks.

In another embodiment, the common reference string is defined as: Rᵢ=(Sig_{authority}(Rᵢ₋₁)), where Rᵢ is generated for the new block.

In another embodiment, the function H is a hash function. The function V is defined as: |R−Hash(Sigₛₖ(status)), where R is the value R and Hash(Sigₛₖ(status) is verified by a public key.

In another embodiment, the node obtains the right to issue the new block when a calculated value for the function V is the minimum at the node by comparing with other calculated values for the function at other nodes. The blocks may pertain to a single blockchain.

The present application further provides a distributed system comprising: a plurality of first nodes determining a value R from a common reference string; and a plurality of second nodes computing a value s associated to a value of a status and computes a value r by taking the value s into a function H and allowing one of the second nodes to issue a new block by taking the values R and r into a function V; wherein the plurality of first nodes and the plurality of second nodes are connected to each other via an internet.

### BRIEF DESCRIPTION OF THE DRAWINGS

In order to sufficiently understand the essence, advantages and the preferred embodiments of the present invention, the following detailed description will be more clearly understood by referring to the accompanying drawings.

FIG. 1 is a block diagram of a system in which some exemplary embodiments of the disclosed subject matter may be implemented.

FIG. 2 is a flow diagram of a process in accordance with some exemplary embodiments of the disclosed subject matter.

FIG. 3 is a flow diagram of a process in accordance with some exemplary embodiments of the disclosed subject matter.

FIG. 4 is a timeline diagram of building a blockchain in accordance with some exemplary embodiments of the disclosed subject matter.

### DETAILED DESCRIPTION OF THE INVENTION

The following description shows the preferred embodiments of the present invention. The present invention is described below by referring to the embodiments and the figures. Thus, the present invention is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

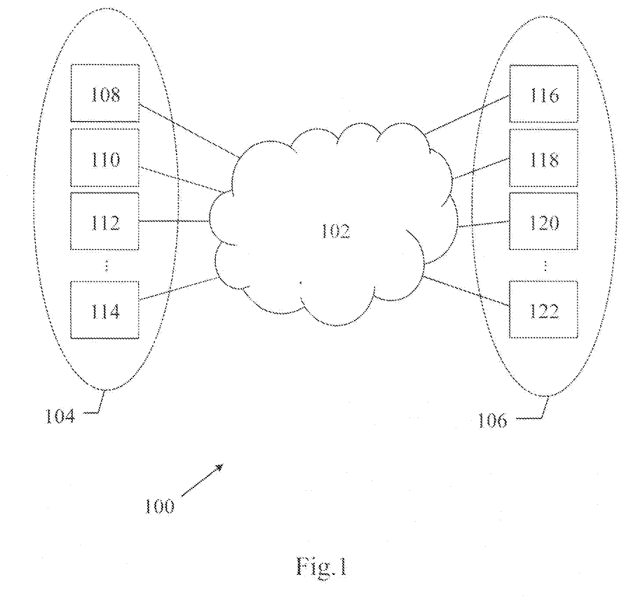

FIG. 1 is a diagram that shows a plurality of nodes 108-122 (e.g., devices, workstations, computers, or miners) connected to an internet 102 and connected to each other via the internet 102. The distributed system 100 in which transactions and records are organized in blocks includes a plurality of nodes 108-122. In the distributed system 100, a user is uniquely identified by its public key (pk) and private key (sk) pair, where the private key is a private signing key corresponding to one of nodes 108-122. All users at the nodes 108-122 can transfer and receive the stakes from other users. The blockchain of the present application is maintained by a special set of users S_{node} where the members of S_{node} are called nodes. All users can also verify the correctness of the blockchain. There are two special sets of nodes of the present application: the CRS (common reference string) set S_{CRS} 104 and the notary set S_{notary} 106 (a node can be in two sets at the same time). The consensus of distributed system 100 is based on proof-of-participation; that is, each node has equal chance to propose a block. One of nodes 108-122 can pack a batch of transactions into a block. A node proposes a block if the block is a candidate that can be selected (i.e., a node is allowed to issue a block if the block is selected and become a block in the blockchain). The blocks may pertain to a single blockchain.

The members in S_{CRS} 104 are responsible for updating the CRS. The members in S_{notary} 106 have right to propose a block and are responsible for deciding whose block can be chosen for the single chain.

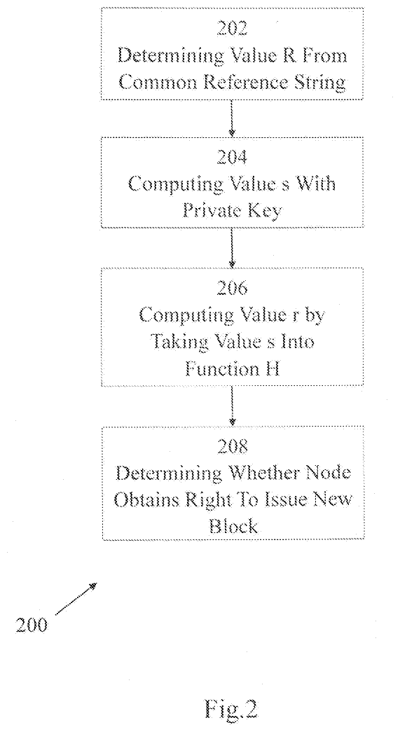

FIG. 2 is a flowchart diagramming a process 200, in accordance with some exemplary embodiments of the disclosed subject matter. Those skilled in the art will appreciate the method illustrated by the flowchart of FIG. 2 is merely exemplary and that alternate variations may be employed, all in accordance with the present technique.

Process 200 begins with step 202, in which the members in S_{CRS} generate a value R from a common reference string (CRS). An epoch consists of a specific number of blocks. The CRS is a public randomness generated by a deterministic algorithm for each epoch; no user in the system can predict the CRS of any future epoch. In an exemplary embodiment, the CRS of epoch i is updated by Rᵢ=Hash(TSig (Rᵢ₋₁)), where Rᵢ is generated for the new block, Hash(⋅) is a hash function that maps arbitrarily long strings to binary strings of fixed length, and TSig(⋅) is a threshold signature function whose input is some set of share-signatures produced during previous blocks (i.e., the CRS nodes compute the randomness according to results from a previous epoch).

In another exemplary embodiment, the common reference string is defined as: Rᵢ=(Sig_{authority}(Rᵢ₋₁)) under Proof-of-Authority blockchain, where Rᵢ is generated for the new block.

At Step 204, each node in S_{notary} computes a value s associated to a value of a status with the private key, and the status is the public predictable information of the block (e.g. shard ID, chain ID or block height). In an exemplary embodiment, each node in S_{notary} computes the signature with its private key sk as: s=Sigₛₖ(status), where Sigₛₖ(status) is a binary string and referred to as the digital signature of the status of the private key sk.

At next step 206, each node in S_{notary} computes a value r by taking value s into a function H, where the function H may be a Hash function. The value r can be verified with the public key and the value s by other nodes.

The value r may be unpredictable and unique to other nodes.

At step 208, the node in S_{notary} determines which node obtains a right to issue a new block by taking the value R and r into a function V. The function V is the verifiable random function (VRF), defined as: |Rᵢ−Hash(Sigₛₖ(status))| where, the Rᵢ is the value R and Hash(Sigₛₖ(status)) is verified by the public key. The node obtains the right to issue the new block when a calculated value for the function V is minimum at the node by comparing with other calculated values for the function at other nodes. To determine which node obtains the right to issue a block by computing:

l_{q}=arg min_{j∈U}_{_{q}}|Rᵢ−Hash(Sigₛₖⱼ(status))|

Where, l_{q} is the node obtaining the right or the leader of node q, the U_{q} is the set of nodes whose signatures are valid, and Sigₛₖⱼ(status) is the digital signature of the status of the private key sk at the node j.

The embodiment adopt a VRF to decide the node q to issue a block. This serves to minimize the communication cost so that a large population can join the protocol. The determination is independent of the round index so that the nodes are not required to propose their values at each round.

Consequently, except for the first round, the running time of each round reduces to 2λ, where λ is a time bound for the messages between any two correct nodes. The blocks may pertain to a single block chain.

The VRF has three benefits compared to the VRF in the prior art. The verifiable random function used in the prior art is Hash(Sigₛₖⱼ(Qᵢ−1; x)), where Qᵢ−1 is the randomness from the previous block. It is troublesome whether an adversary can choose to propose a block depends on the randomness of that adversary's block. If the randomness has advantage for Byzantine nodes (e.g. the probability of proposing a block for next block), then the adversary proposes the block. Thus, the overall advantage of the adversary increases up to (1/3)/(1−1/3)=1/2. The main problem is that the proposer decides the block and the randomness at the same time. Therefore, this embodiment separates the permission of proposing a block and generating the randomness in order to avoid such bias attacks. Second, the configuration is more flexible to compute the function because each user can compute part of the VRF for any status at any time, say, Hash Sigₛₖⱼ(x). At the beginning of each epoch, any user or node can get the CRS of the epoch and compute the probability of proposing a block in the epoch. However, The VRF of the prior art requires Qᵢ₋₁ to compute Qᵢ. Third, the configuration has better space consumption. This embodiment uses the same randomness for many blocks in one epoch. Thus, the space complexity is reduced by a constant.

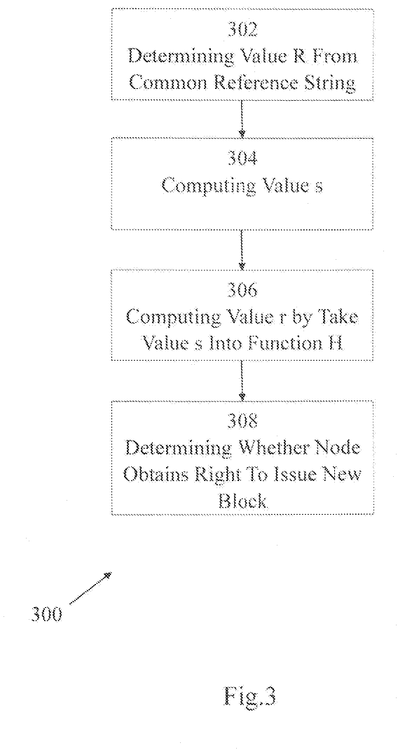

FIG. 3 is a flowchart diagramming a process 300, in accordance with some exemplary embodiments of the disclosed subject matter. Those skilled in the art will appreciate the method illustrated by the flowchart of FIG. 3 is merely exemplary and that alternate variations may be employed, all in accordance with the present technique.

Process 300 begins with step 302, in which the members in S_{CRS} generate a value R from a common reference string (CRS). An epoch consists of a specific number of blocks. The CRS is a public randomness generated by a deterministic algorithm for each epoch; no user in the system can predict the CRS of any future epoch. In an exemplary embodiment, the CRS of epoch i is updated by Rᵢ=Hash(TSig(Rᵢ₋₁)), where Rᵢ is generated for the new block, and TSig(⋅) is a threshold signature function whose input is some set of share-signatures produced during previous blocks (i.e., the CRS nodes compute the randomness according to results from a previous epoch).

In another exemplary embodiment, the common reference string is defined as: Rᵢ=(Sig_{authority}(Rᵢ₋₁)) under Proof-of-Authority blockchain, where Rᵢ is generated for the new block.

At step 304, each node in S_{notary} computes a value s associated to a value of a status, the status is the public predictable information of the block (e.g. shard ID, chain ID or block height), wherein the value s can be verified by other nodes. In an exemplary embodiment, one of node q in S_{notary} computes the value s, and other nodes can verify the value s with public key pk_{q} using zero-knowledge proofs (one party, usually called PROVER, to convince another party, called VERIFIER, that PROVER knows some facts without revealing to the VERIFIER any information about his knowledge).

At step 306, each node in S_{notary} computes a value r by taking value s into a function H, where the function H may be a Hash function. The value r can be verified with the public key and the value s by other nodes. The value r may be unpredictable and unique to other nodes.

At step 308 the node in S_{notary} determines which node obtains a right to issue a new block by taking the value R and r into a function V. The function V is the verifiable random function (VRF), defined as: |Rᵢ−Hash(Sig(status))| where, the Rᵢ is the value R and Hash(Sig(status)) is verified by the public key. The node obtains the right to issue the new block when a calculated value for the function V is minimum at the node by comparing with other calculated values for the function at other nodes. To determine which node obtains the right to issue a block by computing:

l_{q}=arg min_{j∈U}_{_{q}}|Rᵢ−Hash(Sigⱼ(status))|

Where, l_{q} is the node obtaining the right or the leader of node q, the U_{q} is the set of nodes whose signatures are valid, and Sigₛₖⱼ(status) is the digital signature of the status at the node j. This embodiment serves to minimize the communication cost so that a large population can join the protocol. The determination is independent of the round index, so the nodes are not required to propose their values at each round. Consequently, except for the first round, the running time of each round reduces to 2λ, where λ is a time bound for the messages between any two correct nodes. The blocks may pertain to a single block chain.

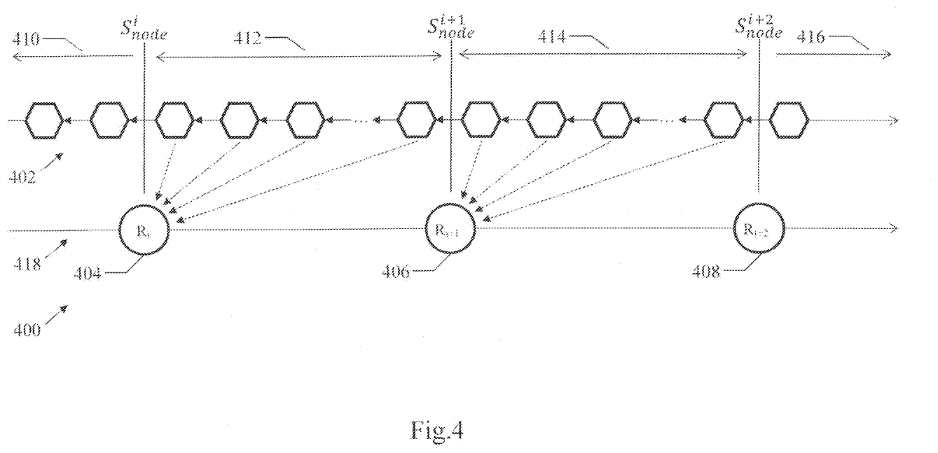

FIG. 4 is a timeline diagram, in accordance with some exemplary embodiments of the disclosed subject matter. Those skilled in the art will appreciate the method illustrated by the flowchart of FIG. 4 is merely exemplary and that alternate variations may be employed, all in accordance with the present technique.

The timeline 400 shows the method for building a single chain of the present invention, the method providing: a single blockchain 402; a plurality of randomness Rᵢ 404, Rᵢ₊₁ 406 and Rᵢ₊₂ 408 of a CRS chain 418; a plurality of epoch: epoch i−1 410, epoch i 412, epoch i+1 414 and epoch i+2 416; and a plurality of valid nodes set S_{node}ⁱ⁻¹, S_{node}ⁱ and S_{node}ⁱ⁺¹.

Any user with enough deposit can register its own public key in the blockchain 402. The users who want to enter or leave S_{node} can announce the request. The request will be recorded in the blocks. The node is called valid if it owns enough deposit and has registered a valid public key. The set S_{node}ⁱ⁺¹ can be updated by S_{node}ⁱ and the blocks in the epoch i 412.

The members in S_{CRS} are responsible for updating the CRS chain 418. The members in S_{notary} have right to propose a block and are responsible for deciding whose block can be chosen for the single chain 402. The decision of whose block can be chosen is determined by the public predictable information status, Rᵢ 404 and the private keys, the node in S_{notary} compute the value |Rᵢ−Hash (Sig_{skq}(status))| locally.

The members in S_{CRS} and S_{notary} are re-elected for each epoch. Each epoch i correspond to the randomness Rᵢ 404 of CRS chain 418. When S_{CRS} is re-elected, the members in S_{CRS} will update the CRS chain 418 for the next epoch. In an exemplary embodiment, the set S_{CRS}ⁱ and the set S_{notary}ⁱ are the CRS set and the notary set of epoch i 412. The set S_{CRS}ⁱ, the set S_{notary}ⁱ and the randomness Rᵢ 404 are decided before the epoch i 412 starts. When the epoch i 412 starts, the members in S_{CRS}ⁱ generate the randomness Rᵢ₊₁ 406 as: Rᵢ₊₁=Hash(TSig(Rᵢ)), where TSig(Rᵢ) is the threshold signature signed by the nodes in S_{CRS}ⁱ. After Rᵢ₊₁406 is decided, the set S_{CRS}ⁱ⁺¹ and the set S_{notary}ⁱ⁺¹ can be elected by Fisher-Yate shuffle with the randomness Rᵢ₊₁406 from the set S_{node}ⁱ. Finally, the members in S_{CRS}ⁱ⁺¹ and S_{notary}ⁱ⁺¹ run the key generation algorithm of the threshold signature scheme, respectively.

According to the present invention, the method and system for a node to issue a new block for building an agreed single chain by using the common reference string (CRS) and verifiable random function (VRF). It minimizes the communication cost and reduces the time bound so that achieving high decentralization and low latency.

The foregoing embodiments of the invention have been presented for the purpose of illustration. Although the invention has been described by certain preceding examples, it is not to be construed as being limited by them. They are not intended to be exhaustive, or to limit the scope of the invention. Modifications, improvements and variations within the scope of the invention are possible in light of this disclosure.

What is claimed is:

1. A method for a node to issue a new block in a distributed system including a plurality of blocks, comprising:
determining a value R from a common reference string;
computing a value s associated to a value of a status with a private key at a node;
computing a value r by taking the value s into a function H at the node; and
determining whether the node obtains a right to issue a new block by taking the values R and r into a function V.

2. The method of claim 1, wherein the private key is a private signing key corresponding to the node.

3. The method of claim 2, wherein the value s can only be computed by the node with the private key.

4. The method of claim 2, wherein the value r is unpredictable and unique to other nodes.

5. The method of claim 1, wherein the value r can be verified with a public key and the value s.

6. The method of claim 1, wherein the status can be defined to be a shard ID of the block.

7. The method of claim 1, wherein the status can be defined to be a chain ID of the block.

8. The method of claim 1, wherein the status can be defined to be a height of the block.

9. The method of claim 1, wherein the common reference string is a public randomness generated by a deterministic algorithm for each epoch.

10. The method of claim 9, wherein the epoch consists of a specific number of blocks.

11. The method of claim 10, wherein the common reference string is defined as:
Rᵢ=Hash(TSig(Rᵢ₋₁)), where Rᵢ is generated for the new block, and
TSig(⋅) is a threshold signature function whose input is some set of share-signatures produced during previous blocks.

12. The method of claim 10, wherein the common reference string is defined as:
Rᵢ=(Sig_{authority}(Rᵢ₋₁)), where Rᵢ is generated for the new block.

13. The method of claim 1, wherein the function H is a hash function.

14. The method of claim 13, wherein the function V is defined as:

|Rᵢ−Hash(Sigₛₖ(status))|, where Rᵢ is the value R and
Hash(Sigₛₖ(status)) is verified by a public key.

15. The method of claim 14, wherein the node obtains the right to issue the new block when a calculated value for the function V is minimum at the node by comparing with other calculated values for the function at other nodes.

16. The method of claim 14, wherein the blocks pertain to a single block chain.

17. A method for a node to issue a new block in a distributed system including a plurality of blocks, comprising:
determining a value R from a common reference string;
computing a value s associated to a value of a status at a node, wherein the value s can be verified by other nodes;
computing a value r by taking the value s into a function H at the node; and
determining whether the node obtains a right to issue a new block by taking the values R and r into a function V.

18. The method of claim 17, wherein the value r is unpredictable and unique to other nodes.

19. The method of claim 17, the value r can be verified with a public key and the value s.

20. The method of claim 17, wherein the status can be defined to be a shard ID of the block.

21. The method of claim 17, wherein the status can be defined to be a chain ID of the block.

22. The method of claim 17, wherein the status can be defined to be a height of the block.

23. The method of claim 17, wherein the common reference string is a public randomness generated by a deterministic algorithm for each epoch.

24. The method of claim 23, wherein the epoch consists of a specific number of blocks.

25. The method of claim 24, wherein the common reference string is defined as:
Rᵢ=Hash(TSig(Rᵢ₋₁)), where R is generated for the new block, and
TSig(⋅) is a threshold signature function whose input is some set of share-signatures produced during previous blocks.

26. The method of claim 24, wherein the common reference string is defined as:
Rᵢ=(Sig_{authority}(Rᵢ₋₁)), where Rᵢ is generated for the new block.

27. The method of claim 1, wherein the function H is a hash function.

28. The method of claim 27, wherein the function V is defined as:

|Rᵢ−Hash(Sig(status))|, where R is the value R and
Hash(Sig(status)) is verified by a public key.

29. The method of claim 27, wherein the node obtains the right to issue the new block when a calculated value for the function V is minimum at the node by comparing with other calculated values for the function at other nodes.

30. The method of claim 29, wherein the blocks pertain to a single block chain.

31. A distributed system including a plurality of blocks comprising:
a plurality of first nodes determining a value R from a common reference string; and
a plurality of second nodes computing a value s associated to a value of a status and computing a value r by taking the value s into a function H, and allowing one of the second nodes to issue a new block by taking the values R and r into a function V;
wherein the plurality of first nodes and the plurality of second nodes are connected to each other via an internet.
